(19) United States
(12) Patent Application Publication
(10) Pub. No.: US 2020/0385292 A1
(43) Pub. Date: Dec. 10, 2020

(54) DEVICES AND METHODS FOR THE REMEDIATION OF GROUNDWATER

(71) Applicant: Chevron U.S.A. Inc., San Ramon, CA (US)

(72) Inventors: David G. THOMAS, Wembley Downs (AU); Roopa KAMATH, Katy, TX (US); Eric DANIELS, Pleasant Hill, CA (US); David A. REYNOLDS, Kingston (CA)

(21) Appl. No.: 16/997,831

(22) Filed: Aug. 19, 2020

Related U.S. Application Data
(62) Division of application No. 16/119,599, filed on Aug. 31, 2018.
(60) Provisional application No. 62/552,572, filed on Aug. 31, 2017.

(51) Int. Cl. C02F 1/469; C02F 1/42; C02F 1/00; C02F 1/461

(52) U.S. Cl. CPC C02F 1/4691; C02F 1/42; C02F 2101/12; C02F 1/46109; C02F 2001/427; C02F 1/008

(57) ABSTRACT

Provided herein are devices, systems, and methods for removing contaminant ions from water within an aquifer. The devices, systems, methods employ an elecrokinetic driving force to induce the migration of charged species towards electrodes, where they can be concentrated and removed from the aquifer. In this way, the devices, systems, methods described herein can be used to economically remediate groundwater contaminated with charged species.

### CROSS-REFERENCE TO RELATED APPLICATIONS

This application claims benefit of U.S. Provisional Application No. 62/552,572, tiled Aug. 31, 2017, which is hereby incorporated herein by reference in its entirety.

### BACKGROUND

There is a significant interest in methods and systems for remediating groundwater. Conventional methods for treating groundwater contamination typically involve the ex situ treatment of water. In such methods, groundwater is brought to the surface (e.g., by pumping) and treated, for example, using electrodialysis or reverse osmosis. While methods for treating groundwater exist, new devices, systems, and methods for groundwater remediation are of significant interest.

### SUMMARY

Provided herein are devices, systems, and methods for removing contaminant ions from water within an aquifer. The devices, systems, methods employ an elecrokinetic driving force to induce the migration of charged species towards electrodes, where they can be concentrated and removed from the aquifer. In this way, the devices, systems, methods described herein can be used to economically remediate groundwater contaminated with charged species.

For example, provided herein are methods for removing contaminant ions from water within an aquifer that comprise (i) inducing flow of the water through a treatment region within the aquifer disposed between an anode and a cathode; (ii) applying an electric field between the anode and the cathode to induce migration of anions in the water to a region proximate to the anode and migration of cations in the water to a region proximate to the cathode; and (iii) withdrawing fluid from the region proximate to the anode and the region proximate to the cathode, thereby removing contaminant ions from the water within the aquifer,

The treatment region within the aquifer can be a region having high permeability. For example, the treatment region within the aquifer can exhibit a hydraulic conductivity of at least 10⁻⁴ cm/sec (e.g., at least 10⁻³ cm/sec, or at least 0.1 cm/sec), as measured by the standard method described in ASTM D5084-16a. In some cases, the treatment region within the aquifer can exhibit a hydraulic conductivity of from 10⁻⁴ cm/sec to 100 cm/sec (e.g., from 10⁻³ cm/sec to 100 cm/sec, or from 0.1 cm/sec to 100 cm/sec), as measured by the standard method described in ASTM D5084-16a.

In some embodiments, the treatment region can be disposed along a path for fluid flow from an injection wellbore in fluid communication with the aquifer to an extraction wellbore spaced apart from the injection wellbore and in fluid communication with the aquifer. In these embodiments, inducing the flow of the water through a treatment region within the aquifer can comprise injecting water through the injection wellbore into the aquifer and extracting water from the aquifer via the extraction wellbore, thereby inducing the flow of the water through the treatment region.

In some embodiments, the treatment region can be disposed along a path for fluid flow from a recirculation well outlet in fluid communication with the aquifer to a recirculation well inlet in fluid communication with the aquifer. In these embodiments, inducing the flow of the water through a treatment region within the aquifer can comprise drawing water through the recirculation well inlet and ejecting water from the recirculation well outlet, thereby inducing the flow of the water through the treatment region.

The anions and cations can comprise any contaminant ions present within the aquifer. For example, the anions can comprise chloride ions, bromide ions, sulfate ions, nitrate, or a combination thereof. The cations can comprise sodium ions, potassium ions, magnesium ions, calcium ions, ammonium ions, iron ions, arsenic ions, chromium ions, lead ions, copper ions, zinc ions, barium ions, or combinations thereof.

In some embodiments, the anode can be positioned within an anode well in fluid communication with the aquifer. In these embodiments, the method can further comprise monitoring the physical and chemical properties of fluid in the anode well. For example, in some cases, the method can further comprise monitoring and maintaining a minimum pH level of fluid in the anode well. By way of example, the method can comprise maintaining the pH of fluid in the anode well within a specified range (e.g., maintaining the pH of fluid in the anode well at a pH of from 4 to 10, or maintaining the pH of fluid in the anode well at a pH of from 5 to 9) by measuring the pH of the fluid in the anode well and adding a pH adjusting solution (e.g., an acid, a base, or a combination thereof) to the anode well. In some embodiments, the method can further comprise monitoring a fluid level in the anode well and adjusting the fluid level in the anode well when the fluid level reaches a predetermined level.

In some embodiments, the cathode can be positioned within a cathode well in fluid communication with the aquifer. in these embodiments, the method can further comprise monitoring the physical and chemical properties of fluid in the cathode well. For example, in some cases, the method can further comprise monitoring and maintaining a minimum pH level of fluid in the cathode well. By way of example, the method can comprise maintaining the pH of fluid in the cathode well within a specified range (e.g., maintaining the pH of fluid in the cathode well at a pH of from 4 to 10, or maintaining the pH of fluid in the cathode well at a pH of from 5 to 9) by measuring the pH of the fluid in the cathode well and adding a pH adjusting solution (e.g., an acid, a base, or a combination thereof) to the cathode well. In some embodiments, the method can further comprise monitoring a fluid level in the cathode well and adjusting the fluid level in the cathode well when the fluid level reaches a predetermined level.

Also provided are systems that can be used to practice the methods described above. For example, provided herein are systems that comprise an injection wellbore in fluid communication with an aquifer and an extraction wellbore spaced apart from the injection wellbore and in fluid communication with the aquifer, thereby defining a path for fluid flow within the aquifer from the injection wellbore to the extraction wellbore; an anode well in fluid communication with the aquifer; a cathode well spaced apart from the anode well and in fluid communication with the aquifer; and a treatment region within the aquifer disposed between the anode well and the cathode well, wherein the treatment region is disposed along the path for fluid flow within the aquifer from the injection wellbore to the extraction wellbore.

Also provided herein are systems that comprise a recirculation well in fluid communication with an aquifer, the recirculation well comprising a fluid inlet and. a fluid outlet spaced apart from the fluid inlet, thereby defining a path for fluid flow within the aquifer from the fluid outlet to the fluid inlet; an anode well in fluid communication. with the aquifer; a cathode well spaced apart from the anode well and in fluid communication with the aquifer; and a treatment region within the aquifer disposed between the anode well and the cathode well, wherein the treatment region is disposed along the path for fluid flow within the aquifer from the fluid outlet to the fluid inlet.

The treatment region within the aquifer can be a region having high permeability. For example, the treatment region within the aquifer can exhibit a hydraulic conductivity of at least 10⁻⁴ cm/sec (e.g., at least 10⁻³ cm/sec, or at least 0.1 cm/sec), as measured by the standard method described in ASTM D5084-16a. in some cases, the treatment region within the aquifer can exhibit a hydraulic conductivity of from 10⁻¹ cm/sec to 100 cm/sec (e.g., from 10 ⁻³ cm/sec to 100 cm/sec, or from 0.1 cm/sec to 100 cm/sec), as measured by the standard method described in ASTM D5084-16a.

Also provided are devices that can be used to remove contaminant ions from water within an aquifer. These devices can be in-well desalinations systems that can be operated to remove contaminant ions when positioned within a wellbore in fluid communication with an aquifer.

For example, provided herein are recirculation wells that comprise a tubular casing having an outer wall and an inner wall defining an internal passageway axially extending from an uphole region to a downhole region; a central conduit having an outer wall and an inner wall, the central conduit axially extending from the uphole region through the internal passageway to terminate in a discharge port positioned within the downhole region; and a concentric electrode assembly positioned within the impermeable body portion of the casing. In some embodiments, the diameter of the tubular casing can be from 4 inches to 24 inches. The casing can comprise a fluid inlet fluidly connecting the outer wall of the casing to the internal passageway; a fluid outlet fluidly connecting the outer wall of the casing to the internal passageway; and an impermeable body portion disposed between and axially separating the fluid inlet and the fluid outlet. In some cases, the fluid inlet, the fluid outlet, or a combination thereof can comprise a region of the casing formed from a screen or mesh.

The concentric electrode assembly can comprise a first electrode circumferentially disposed about the inner wall of the casing; and a second electrode opposite the first electrode and circumferentially disposed about the outer wall of the central conduit. Within the impermeable body portion of the casing, the inner wall of the casing and the outer wall of the central conduit can together define an annular path for fluid flow axially extending from the fluid inlet, between the first electrode and the second electrode of the concentric electrode assembly, and to the fluid outlet. In some embodiments, the first electrode can be separated from the second electrode by a distance of from 2 inches to 12 inches.

In some embodiments, the recirculation well can further comprise a low permeability membrane (e.g., an engineered membrane that permits passage of certain ions across the membrane while providing resistance to/limiting the physical flow/transfer of water across the membrane) disposed between the annular path for fluid flow and the first electrode. The low permeability membrane can be spaced apart from the first electrode so as to form an accumulation reservoir between the first electrode and the low permeability membrane. In some embodiments, the recirculation well can further comprise a low permeability membrane (e.g., an engineered membrane that permits passage of certain ions across the membrane while providing resistance to/limiting the physical flow/transfer of water across the membrane) disposed between the annular path for fluid flow and the second electrode. The low permeability membrane can be spaced apart from the second electrode so as to form an accumulation reservoir between the second electrode and the low permeability membrane. The low permeability membranes can comprise an ion exchange polymer. For example the low permeability membranes can comprise an anion exchange resin, a cation exchange resin, or a mixed bed ion exchange resin.

In some cases, the recirculation well can further comprise a port fluidly connecting a withdrawal conduit to the accumulation reservoir between the first electrode and the low permeability membrane, to the accumulation reservoir between the second electrode and the low permeability membrane, or a combination thereof. The withdrawal conduit can be in fluid combination with a pump, and configured to allow fluid to be withdrawn from the accumulation reservoir between the first electrode and the low permeability membrane, from the accumulation reservoir between the second electrode and the low permeability membrane, or a combination thereof.

In some embodiments, the recirculation well can further comprise a power source electrically connected to the first electrode and the second electrode and configured to apply an electric field between the first electrode and the second electrode.

In some embodiments, the recirculation well can further comprise a pump operatively connected to the central conduit and configured to provide a flow of a gas (e.g., air) from the discharge port into the internal passageway.

Also provided are methods for removing contaminant ions from water within an aquifer using the recirculation wells provided herein. For example, provided herein are methods for removing contaminant ions from water within an aquifer that comprise (i) positioning a recirculation well described herein within a wellbore in fluid communication with the aquifer; (ii) inducing flow of the water within the aquifer through the recirculation well along the annular path for fluid flow axially extending from the fluid inlet, between the first electrode and the second electrode of the concentric electrode assembly, and to the fluid outlet; (iii) applying an electric field between the first electrode and the second electrode to induce migration of ions in the water to regions proximate to the first electrode and the second electrode; and (iv) withdrawing the ions from the regions proximate to the first electrode and the second electrode, thereby removing contaminant ions from the water within the aquifer.

In some embodiments, the first electrode comprises a cathode and the second electrode comprises an anode, and step (iii) comprises applying an electric field between the cathode and the anode to induce migration of cations in the water to a region proximate to the cathode and migration of anions in the water to a region proximate to the anode. In other embodiments, the first electrode comprises an anode and the second electrode comprises a cathode, and step (iii) comprises applying an electric field between the cathode and the anode to induce migration of cations in the water to a region proximate to the cathode and migration of anions in the water to a region proximate to the anode.

The anions and cations can comprise any contaminant ions present within the aquifer. For example, the anions can comprise chloride ions, bromide ions, sulfate ions, nitrate, or a combination thereof. The cations can comprise sodium ions potassium ions, magnesium ions, calcium ions, ammonium ions, iron ions, arsenic ions, chromium ions, lead ions, copper ions, zinc ions, barium ions, or combinations thereof.

In some embodiments, step (ii) can comprise providing a flow of a gas (e.g., air) from the discharge port into the internal passageway.

Also provided are in-well system for removing contaminant ions from water within an aquifer that comprise a tubular casing having an outer wall and an inner wall defining an internal passageway axially extending from an uphole region to a downhole region; and a concentric electrode assembly positioned within the impermeable body portion of the casing. In some embodiments, the diameter of the tubular casing can be from 4 inches to 24 inches. The casing can comprise a fluid inlet fluidly connecting the outer wall of the casing to the internal passageway; and an impermeable body portion disposed between and axially separating the fluid inlet and the uphole region. In some cases, the fluid inlet can comprise a region of the casing formed from a screen or mesh

The concentric electrode assembly can comprise a first electrode circumferentially disposed about the inner wall of the casing; and a second electrode opposite the first electrode and axially extending through the internal passageway. Within the impermeable body portion of the casing, the inner wall of the casing and the second electrode together define a path for fluid flow axially extending from the fluid inlet, and through the internal passageway between the first electrode and the second electrode of the concentric electrode assembly. In some embodiments, the first electrode can be separated from the second electrode by a distance of from 2 inches to 12 inches.

In some embodiments, the in-well system can further comprise a low permeability membrane (e.g., an engineered membrane that permits passage of certain ions across the membrane while providing resistance to/limiting the physical flow/transfer of water across the membrane) disposed between the path for fluid flow and the first electrode. The low permeability membrane can be spaced apart from the first electrode so as to form an accumulation reservoir between the first electrode and the low permeability membrane. In some embodiments, the in-well system can further comprise a low permeability membrane (e.g., an engineered membrane that permits passage of certain ions across the membrane while providing resistance to/limiting the physical flow/transfer of water across the membrane) disposed between the path for fluid flow and the second electrode. The low permeability membrane can be spaced apart from the second electrode so as to form an accumulation reservoir between the second electrode and the low permeability membrane. The low permeability membranes can comprise an ion exchange polymer. For example, the low permeability membranes can comprise an anion exchange resin, a cation exchange resin, or a mixed bed ion exchange resin.

In some cases, the in-well system can further comprise a port fluidly connecting a withdrawal conduit to the accumulation reservoir between the first electrode and the low permeability membrane, to the accumulation reservoir between the second electrode and the low permeability membrane, or a combination thereof. The withdrawal conduit can be in fluid combination with a pump, and configured to allow fluid to be withdrawn from the accumulation reservoir between the first electrode and the low permeability membrane, from the accumulation reservoir between the second electrode and the low permeability membrane, or a combination thereof.

In some embodiments, the in-well system can further comprise a power source electrically connected to the first electrode and the second electrode and configured to apply an electric field between the first electrode and the second electrode.

In some embodiments, the in-well system can further comprise a pump operatively connected to the internal passageway and configured to provide a flow of water from the fluid inlet, and through the internal passageway between the first electrode and the second electrode of the concentric electrode assembly.

Also provided are methods for removing contaminant ions from water within an aquifer using the in-well systems described above. For example, provided herein are methods for removing contaminant ions from water within an aquifer that comprise (i) positioning an in-well system described herein within a wellbore in fluid communication with the aquifer; (ii) inducing flow of the water within the aquifer through the in-well system along the path for fluid flow axially extending from the fluid inlet, and through the internal passageway between the first electrode and the second electrode of the concentric electrode assembly; (iii) applying an electric field between the first electrode and the second electrode to induce migration of ions in the water to regions proximate to the first electrode and the second electrode; and (iv) withdrawing the ions from the regions proximate to the first electrode and the second electrode, thereby removing contaminant ions from the water within the aquifer,

In some embodiments, the first electrode comprises a cathode and the second electrode comprises an anode, and step (iii) comprises applying an electric field between the cathode and the anode to induce migration of cations in the water to a region proximate to the cathode and migration of anions in the water to a region proximate to the anode. In other embodiments, the first electrode comprises an anode and the second electrode comprises a cathode, and step (iii) comprises applying an electric field between the cathode and the anode to induce migration of cations in the water to a region proximate to the cathode and migration of anions in the water to a region proximate to the anode.

The anions and cations can comprise any contaminant ions present within the aquifer. For example, the anions can comprise chloride ions bromide ions, sulfate ions, nitrate, or a combination thereof. The cations can comprise sodium ions, potassium ions, magnesium ions, calcium ions, ammonium ions, iron ions, arsenic ions, chromium ions, lead ions, copper ions, zinc ions, barium ions, or combinations thereof.

### DESCRIPTION OF DRAWINGS

FIG. 1 is schematic illustration of an example system and method for the remediation of groundwater.

FIG. 2 is schematic illustration of an example system and method for the remediation of groundwater.

FIG. 3 is schematic illustration of an example system and method for the remediation of groundwater.

FIG. 4A is a schematic illustration of an example recirculation well that can be used to remove contaminant ions from water within an aquifer.

FIG. 4B is a vertical cross section of an example recirculation well that can be used to remove contaminant ions from water within an aquifer.

FIG. 4C is a horizontal cross section of an example recirculation well that can be used to remove contaminant ions from water within an aquifer.

FIG. 5A is a schematic illustration of an example in-well system that can be used to remove contaminant ions from water within an aquifer.

FIG. 5B is a vertical cross section of an example in-well system that can he used to remove contaminant ions from water within an aquifer.

FIG. 5C is a horizontal cross section of an example: in-well system that can be used to remove contaminant ions from water within an aquifer.

### DETAILED DESCRIPTION

Provided herein are devices, systems, and methods for removing contaminant ions from water within an aquifer. The devices, systems, methods employ an elecrokinetic driving force to induce the migration of charged species towards electrodes, where they can be concentrated and removed from the aquifer. In this way, the devices, systems, methods described herein can be used to economically remediate groundwater contaminated with charged species,

As used herein, “ground surface” refers to the surface of the earth upon which man and his surroundings naturally rest or move; “groundwater” refers to subterranean water found in the surface soil of the crust of the earth; “subterranean” refers to existing, lying, or situated below the surface of the earth; “aquifer” refers to a water-bearing subterranean stratum in which the groundwater occurs; “plume” of contaminated groundwater represents an area of groundwater within the aquifer that contains one or more contaminants in concentrations above acceptable levels; the “vadose” zone extends between the ground surface and the top of the water level in the aquifer.

The devices, systems, and methods described herein can be used to remove contaminant ions from regions of relatively high hydraulic conductivity. In this respect, the devices, systems, and methods described herein can be distinguished from electroosmotic and electrokinetic remediation methods that operate in relatively low conductivity media (e.g., fine grained soils).

Hydraulic conductivity can be determined, for example, using the standard methods described in ASTM D5084-16a, entitled “Standard Test Methods for Measurement of Hydraulic Conductivity of Saturated Porous Materials Using a Flexible Wall Permeameter” which is hereby incorporated by reference in its entirety. Typical ranges for the hydraulic conductivity of certain soil types are included in the table below for reference.

| | Range of Hydraulic Conductivity, |
|---|---|
| Soil Type | cm/sec |
| Gravel | 0.1 to 100 |
| Clean Sand | 10⁻³ to 1 |
| Silty Sand | 10⁻⁵ to 0.1 |
| Silt, Loess | 10⁻⁷ to 10⁻³ |
| Glacial Till | 10⁻¹⁰ to 10⁻⁴ |

In some embodiments, the groundwater treated using the devices, systems, and methods described herein occurs in an aquifer exhibit a hydraulic conductivity of at least 10⁻⁴ cm/sec (e.g., at least 10⁻³ cm/sec, or at least 0.1 cm/sec), as measured by the standard methods described in ASTM D5084-16a. For example, in some embodiments, the treatment region within the aquifer can exhibit a hydraulic conductivity of at least 10⁻⁴ cm/sec (e.g., at least 10⁻³ cm/sec, at least 0.01 cm/sec, at least 0.05 cm/sec, at least 0.1 cm/sec, at least 0.5 cm/sec, at least 1.0 cm/sec, at least 5.0 cm/sec, at least 10 cm/sec, or at least 50 cm/sec), as measured by the standard methods described in ASTM D5084-16a. In some embodiments, the treatment region within the aquifer can exhibit a hydraulic conductivity of 100 cm/sec or less (e.g., 50 cm/sec or less, 10 cm/sec or less, 5 cm/sec or less, 1 cm/sec or less, 0.5 cm/sec or less, 0.1 cm/sec or less, 0.05 cm/sec or less, 0.01 cm/sec or less, or 10⁻³ cm/sec or less), as measured by the standard methods described in A S™ D5084-16a.

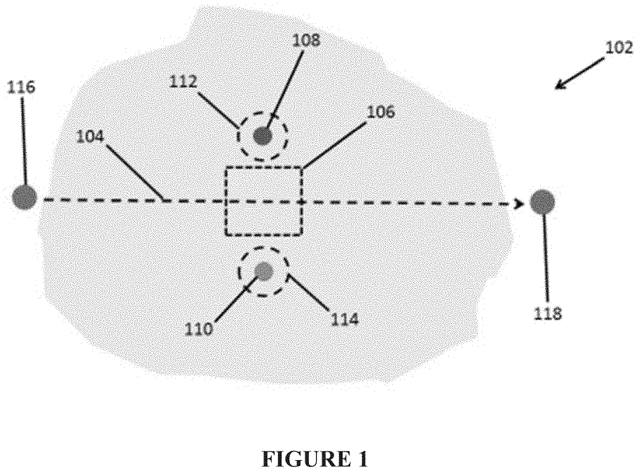

The treatment region can exhibit a hydraulic conductivity ranging from any of the minimum values described above to any of the maximum values described above. For example, in some embodiments, the region can exhibit a hydraulic conductivity of from 10⁻⁴ cm/sec to 100 cm/sec (e.g., from 10⁻³ cm/sec to 100 cm/sec, from 0.01 cm/sec to 100 cm/sec, from 0.01 cm/sec to 10 cm/sec, from 0.1 cm/sec to 100 cm/sec, or from 0.1 cm/sec to 10 cm/sec as measured by the standard method described in ASTM D5084-16a. p Provided herein are systems and methods for the remediation of groundwater. Referring now to FIG. 1, provided herein are methods for removing contaminant ions from water within an aquifer (102) that comprise (i) inducing flow of the water through a treatment region (106) within the aquifer (102) disposed between an anode (108) and a cathode (110); (ii) applying an electric field between the anode (108) and the cathode (110) to induce migration of anions in the water to a region proximate to the anode (112) and migration of cations in the water to a region proximate to the cathode (114); and (iii) withdrawing fluid from the region proximate to the anode (112) and the region proximate to the cathode (114), thereby removing contaminant ions from the water within the aquifer.

As discussed above, the treatment region (106) within the aquifer (102) can be a region having high permeability. For example, the treatment region within the aquifer can exhibit a hydraulic conductivity of at least 10⁻⁴ cm/sec (e.g., at least 10⁻³ cm/sec, or at least 0.1 cm/sec), as measured by the standard method described in ASTM D5084-16a. In some cases, the treatment region within the aquifer can exhibit a hydraulic conductivity of from 10⁻⁴ cm/sec to 100 cm/sec (e.g., from 10⁻³ cm/sec to 100 cm/sec, or from 0.1 cm/sec to 100 cm/sec), as measured by the standard method described in ASTM D5084-16a.

The anions and cations can comprise any contaminant ions present within the aquifer. In some cases, the contaminant ions can comprise monovalent ions, divalent ions, trivalent ions, tetravalent ions, or combinations thereof. In some examples, the anions can comprise chloride ions, bromide ions, sulfate ions, nitrate, or a combination thereof. In some examples, the cations can comprise sodium ions, potassium ions, magnesium ions, calcium ions, ammonium ions, iron ions, arsenic ions, chromium ions, lead ions, copper ions, zinc ions, barium ions, or combinations thereof. In some examples, the contaminants may be strongly or weakly charged complexes. In some cases, the contaminants may be particles that have a net positive or negative charge in a fluid due to surface and/or shape effects (e.g., clay or other solid particles with angular shapes where net negative charges can build up on particle edges).

Referring again to FIG. 1, in some embodiments, the treatment region (106) can be disposed along a path for fluid flow (104) from an injection wellbore (116) in fluid. communication with the aquifer (102) to an extraction wellbore (118) spaced apart from the injection wellbore and in fluid communication with the aquifer. In these embodiments, inducing the flow of the water through a treatment region within the aquifer can comprise injecting water through the injection wellbore (116) into the aquifer and extracting water from the aquifer via the extraction wellbore (118), thereby inducing the flow of the water through the treatment region (106).

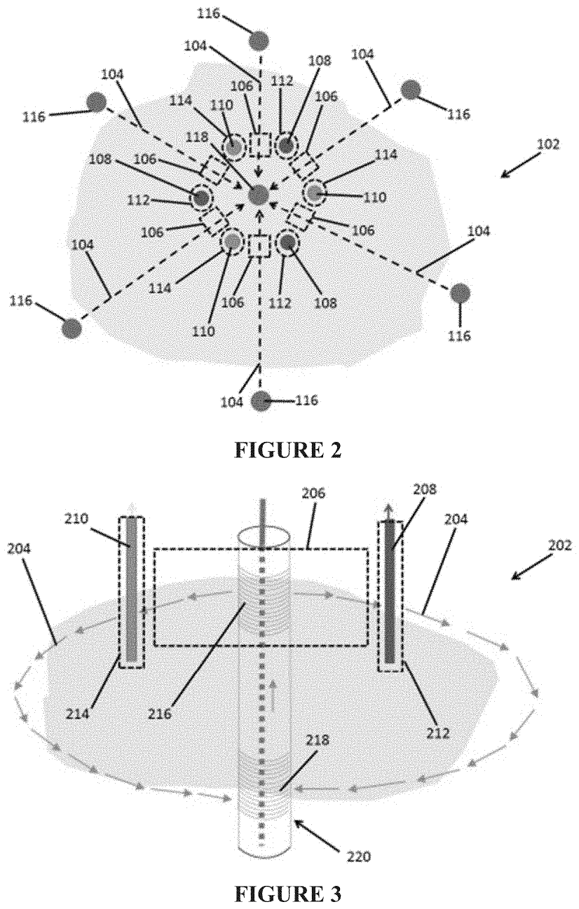

Referring now to FIG. 2, in some embodiments, a plurality of treatment regions (106) can be disposed along a plurality of paths for fluid flow (104) from each of a plurality of injection wellbores (116) in fluid communication with the aquifer (102) to an extraction wellbore (118) spaced apart from each of the plurality of injection wellbores and in fluid communication with the aquifer. Each of the plurality of treatment regions (106) within the aquifer (102) is disposed between an anode (108) and a cathode (110). In these embodiments, the migration of anions in the water to a region proximate to each of the anodes (112) and migration of cations in the water to a region proximate to each of the cathodes (114) can be induced by applying an electric field between the anodes (108) and the cathodes (110). Fluid can then be withdrawn from regions proximate to the anodes (112) and regions proximate to the cathode (114), thereby removing contaminant ions from the water within the aquifer.

Referring now to FIG. 3, in other embodiments, the treatment region (206) can be disposed along a path for fluid flow (204) from a recirculation well outlet (216) in fluid communication with the aquifer (202) to a recirculation well inlet (218) in fluid communication with the aquifer. The treatment region (206) within the aquifer (202) is disposed between an anode (208) and a cathode (210). In these embodiments, inducing the flow of the water through a treatment region (206) within the aquifer (204) can comprise drawing water through the recirculation well inlet (218) and ejecting water from the recirculation well outlet (216), thereby inducing the flow of the water through the treatment region (206). The migration of anions in the water to a region proximate to the anode (212) and migration of cations in the water to a region proximate to the cathode (214) can be induced by applying an electric field between the anode (208) and the cathode (210). Fluid can then be withdrawn from the region proximate to the anode (212) and the region proximate to the cathode (214), thereby removing contaminant ions from the water within the aquifer (202).

In some embodiments, the electrodes above (e.g., the anode(s), the cathode(s), or both the anode(s) and the cathode(s)) can be positioned within a well (e.g., an anode well or a cathode well) in fluid communication with the aquifer. During electrokinetic processing, water in the immediate vicinity of the electrodes can be electrolyzed to produce H⁺ ions at the anode and OH⁻ ions at the cathode, causing the pH of the water to change, according to the following equations.

Anode Reaction

H₂O→O₂+4e⁻+4H⁺ Equation (1)

Cathode Reaction

2H₂O+2e⁻→H₂+2OH⁻ Equation (2)

If the ions produced are not removed or neutralized, these reactions lower the pH at the anode and raise the pH at the cathode. Protons formed at the anode migrate towards the cathode and can aid in contaminant removal by solubilizing certain types of contaminants to form ionic species that are readily transported via electromigration. In contrast, the negatively charged hydroxyl ions formed at the cathode do not migrate as efficiently as protons having a predominantly negative charge and can increase the pH in the cathode region to as high as a pH of 12. An increase of pH can cause deposition of insoluble species and precipitation of soluble species at or in the vicinity of the cathode thereby forming regions of high electrical resistivity and lowering the rate of electroosmotic flow. These types of pH changes can have a significant effect on the water's ζ-potential, solubility, ionic state and charge, and the adsorption of contaminants. For these reasons, it can be desirable to control the pH of the fluids in the vicinity of the electrodes as well as the volume and type of fluid transported from the anode to the cathode. Thus, in some embodiments, methods can further comprise monitoring the physical and chemical properties of fluid in the anode well, the cathode well, or a combination thereof.

For example, in some cases, the method can further comprise monitoring and maintaining a minimum pH level of fluid in the anode well. By way of example, the method can comprise maintaining the pH of fluid in the anode well within a specified range (e.g., maintaining the pH of fluid in the anode well at a pH of from 4 to 10, or maintaining the pH of fluid in the anode well at a pH of from 5 to 9) by measuring the pH of the fluid in the anode well and adding a pH adjusting solution (e.g., an acid, a base, or a combination thereof) to the anode well. in some embodiments, the method can further comprise monitoring a fluid level in the anode well and adjusting the fluid level in the anode well when the fluid level reaches a predetermined level.

In some cases, the method can further comprise monitoring and maintaining a maximum pH level of fluid in the cathode well. By way of example, the method can comprise maintaining the pH of fluid in the cathode well within a specified range (e.g., maintaining the pH of fluid in the cathode well at a pH of from 4 to 10, or maintaining the pH of fluid in the cathode well at a pH of from 5 to 9) by measuring the pH of the fluid in the cathode well and adding a pH adjusting solution (e.g., an acid, a base, or a combination thereof) to the cathode well. In some embodiments, the method can further comprise monitoring a fluid level in the cathode well and adjusting the fluid level in the cathode well when the fluid level reaches a predetermined level.

Also provided are systems that can be used to practice the methods described above. For example, referring again to FIG. 1, provided herein are systems that comprise an injection wellbore (116) in fluid communication with an aquifer (102) and an extraction wellbore (118) spaced apart from the injection wellbore and in fluid communication with the aquifer, thereby defining a path for fluid flow (104) within the aquifer from the injection wellbore to the extraction wellbore; an anode well (108) in fluid communication with the aquifer; a cathode well (110) spaced apart from the anode well and in fluid communication with the aquifer; and a treatment region (106) within the aquifer disposed between the anode well and the cathode well, wherein the treatment region is disposed along the path for fluid flow within the aquifer from the injection wellbore to the extraction wellbore.

Referring again to FIG. 3, also provided herein are systems that comprise a recirculation well (220) in fluid communication with an aquifer (202), the recirculation well comprising a fluid inlet (218) and a fluid outlet (216) spaced apart from the fluid inlet, thereby defining a path for fluid flow (204) within the aquifer from the fluid outlet to the fluid inlet; an anode well (208) in fluid communication with the aquifer; a cathode well (210) spaced apart from the anode well and in fluid communication with the aquifer; and a treatment region (206) within the aquifer disposed between the anode well and the cathode well, wherein the treatment region is disposed along the path for fluid flow within the aquifer from the fluid outlet to the fluid inlet.

Also provided are devices that can be used to remove contaminant ions from water within an aquifer. These devices can be in-well desalinations systems that can be operated to remove contaminant ions when positioned within a wellbore in fluid communication with an aquifer.

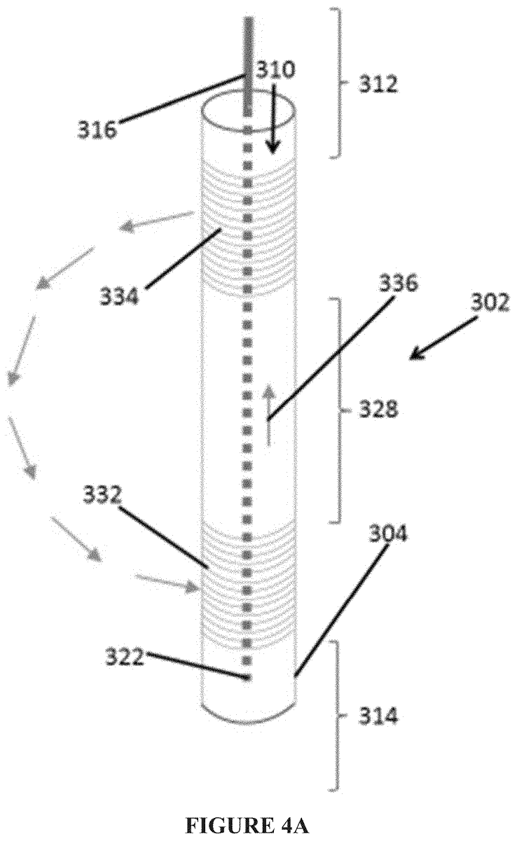

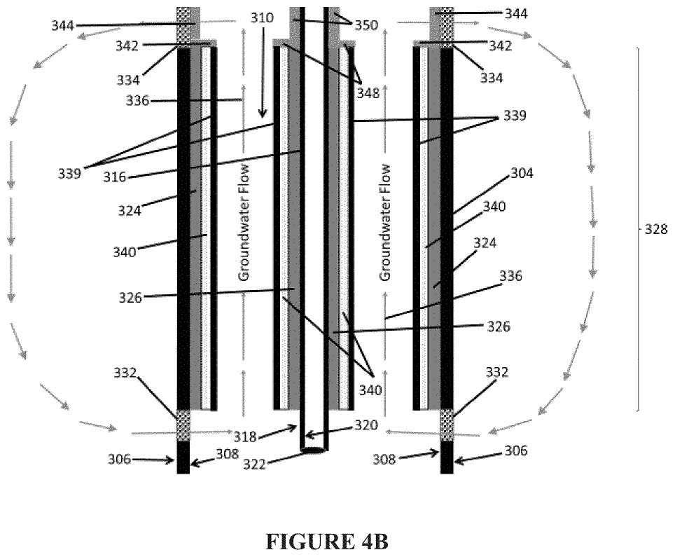

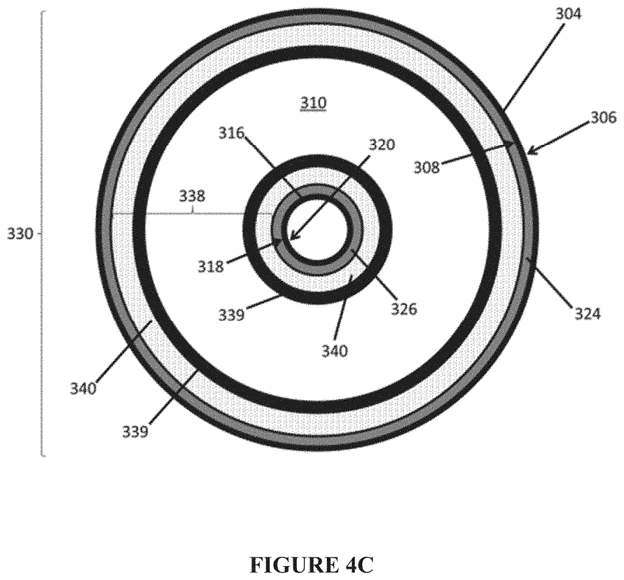

The in-well desalination system can be, for example, a recirculation well that removes contaminant ions from water as it circulates through the recirculation well. For example, referring now to FIGS. 4A.-4C, provided herein are recirculation wells (302) that comprise a tubular casing (304) having an outer wall (306) and an inner wall (308) defining an internal passageway (310) axially extending from an uphole region (312) to a downhole region (314); a central conduit (316) having an outer wall (318) and an inner wall (320), the central conduit axially extending from the uphole region through the internal passageway to terminate in a discharge port (322) positioned within the downhole region; and a concentric electrode assembly (324 and 326 in combination) positioned within an impermeable body portion (328) of the casing. In some embodiments, the diameter (330, outer diameter) of the tubular casing can be from 4 inches to 24 inches (e.g., from 7 inches to 14 inches). The casing can comprise a fluid inlet (332) fluidly connecting the outer wall of the casing to the internal passageway; a fluid outlet (334) fluidly connecting the outer wall of the casing to the internal passageway; and the impermeable body portion (328) disposed between and axially separating the fluid inlet (332) and the fluid outlet (334). In some cases, the fluid inlet, the fluid outlet, or a combination thereof can comprise a region of the casing formed from a screen or mesh.

The concentric electrode assembly can comprise a first electrode (324) circumferentially disposed about the inner wall (308) of the casing; and a second electrode (326) opposite the first electrode and circumferentially disposed about the outer wall (318) of the central conduit. The electrodes can comprise a conductive material, such as a metal, disposed on or within the inner wall of the casing and/or the outer wall of the central conduit. Alternatively, the electrodes can be a portion of the inner wall of the casing and/or the outer wall of the central conduit that is formed from a conductive material, such as a metal (i.e., the casing and/or the central conduit can function as the electrode). In some cases, the first electrode can comprise an anode and the second electrode can comprise a cathode. In other cases, the first electrode can comprise a cathode and the second electrode can comprise an anode.

Within the impermeable body portion (328) of the casing, the inner wall (308) of the casing and the outer wall (306) of the central conduit can together define an annular path for fluid flow (336) axially extending from the fluid inlet (332), between the first electrode (324) and the second electrode (326) of the concentric electrode assembly, and to the fluid outlet (334). In some embodiments, the first electrode (324) can be separated from the second electrode (326) by a distance (338) of from 2 inches to 12 inches (e.g., from 2 inches to 6 inches, or from 4 inches to 8 inches).

In some embodiments, a low permeability membrane (339) can be disposed between the annular path for fluid flow (336) and the first electrode (324), disposed between the annular path for fluid flow (336) and the second electrode (326), or a combination thereof. The low permeability membrane can be an engineered membrane that permits passage of certain ions across the membrane while providing resistance to/limiting the physical flow/transfer of water across the membrane. In some embodiments, the low permeability membrane can exclude ions having a certain size and/or property (e.g., a size exclusion membrane to selectively remove ions). The low permeability membrane can be hydrophobic or hydrophilic and/or oleophobic or oleophilic depending on the performance requirements for a particular application. Examples of suitable low permeability membranes include porous polymer membranes (e.g., hydrophilic membranes, hydrophobic membranes, neutral membranes that exhibit similar water and oil permeability, and combinations thereof), zeolite membranes and ion exchange polymer membranes.

In certain examples, the low permeability membrane can comprise an ion exchange polymer. For example, the low permeability can comprise an anion exchange resin, a cation exchange resin, or a mixed bed ion exchange resin. Suitable ion exchange polymers generally, include a polymer matrix and functional groups ‘paired’ with an exchangeable ion form. The exchangeable ion form is generally one or more of Na⁺, H⁺, or Cl⁻ ions, depending on the type of ion exchangeable resin. These exchangeable ions exchange with the contaminant ions electrokinetically transported to the low permeability membrane.

In the case of a low permeability membrane disposed on an anode, the low permeability membrane can comprise a mixed bed resin, an anion exchange resin, or a combination thereof Commercially available anion exchange resins are typically in either OH⁻ Cl⁻ forms. In certain embodiments, the low permeability membrane can comprise an anion exchange resin in the OH⁻ form.

In the case of a low permeability membrane disposed on a cathode, the low permeability membrane can comprise a mixed bed resin, a cation exchange resin, or a combination thereof. Commercially available cation exchange resins are typically in either H⁺ or Na⁺ forms. In certain embodiments, the low permeability membrane can comprise a cation exchange resin in the H⁺ form.

Examples of illustrative polymer matrices include polystyrene, polystyrene and styrene copolymers, polyacrylate, aromatic substituted vinyl copolymers, polymethacrylate, phenol-formaldehyde, polyalkylamine, copolymers thereof, and blends thereof. In some examples, the polymer matrix can comprise polystyrene and styrene copolymers, polyacrylate, polymethacrylate, styrenedivinylbenzene copolymers, copolymers thereof, and blends thereof.

Examples of illustrative functional groups in cation ion exchange polymers include sulfonic acid groups (—SO₃H), phosphonic acid groups (—PO₃H), phosphinic acid groups (—PO₂H), carboxylic acid groups (—COOH or C(CH₃)—COOH), and combinations thereof. In some embodiments, the functional groups can be chosen from —SO₃H, —PO₃H, and —COOH. In certain embodiments, the functional groups can comprise sulfonic acid groups.

Examples of illustrative functional groups in anion ion exchange polymers include quaternary ammonium groups, e.g., benzyltrimethylammonium groups (also termed type 1 resins), benzyldimethylethanolammonium groups (also termed type 2 resins), trialkylbenzyl ammonium groups (also termed type I resins); or tertiary amine functional groups, and the like. In some embodiments, the functional groups can be chosen from trialkylbenzyl ammonium, trimethylbenzyl ammonium, dimethyl-2-hydroxyethylbenzyl ammonium, and combinations thereof. In certain embodiments, the functional groups can comprise trialkylbenzyl ammonium groups.

Examples of commercially available ion exchange polymers include, for example, materials from Rohm & Haas of Philadelphia, Pa. as Amberlite™ (e.g., Amberlite™ MB-150 mixed bed resin), Amberjee™, Duolite™, and Imac™ resins, from Bayer of Leverkusen, Germany as Lewatit™ resin, from Dow Chemical of Midland, Mich. as Dowex™ resin (e.g., Dowex™ MR-3 LC NG Mix mixed bed resin or Dowex™ MR.-450 UPW mixed bed resin), from Mitsubishi Chemical of Tokyo, Japan as Diaion™ and Relite™ resins, from Purolite of Bala Cynwyd, Pa. as Purolite™ resin, from Sybron of Birmingham, N.J. as Ionac™ resin (e.g., Sybron Ionac™ NM-60 mixed bed resin), from Resintech of West Berlin, N.J., and the like.

The low permeability membrane (339) can be spaced apart from the first electrode 324) and spaced apart from the second electrode (326), so as to form an accumulation reservoir (340) between the first electrode (324) and the low permeability membrane, and an accumulation reservoir (340) between the first electrode (324) and the membrane. During device operation, application of an electric field between the first electrode (324) and the second electrode (326) can induce migration of cations in the water through the low permeability membranes (339), and into the accumulation reservoirs (340).

Referring now to FIG. 4B, in some cases, the recirculation well can further comprise a port (342) fluidly connecting a withdrawal conduit (344) to an accumulation reservoir (340) between the first electrode (324) and the low permeability membrane (339), a port (348) fluidly connecting a withdrawal conduit (350) to an accumulation reservoir (340) between the second electrode (326) and the low permeability membrane (339), or a combination thereof. The withdrawal conduits (344, 350) can be in fluid combination with a pump, and configured to allow fluid to be withdrawn from the accumulation reservoirs (339). In this way, contaminant ions electrokinetically concentrated in the accumulation reservoirs (339) during device operation can be removed from the aquifer.

In some embodiments, the recirculation well can further comprise a power source electrically connected to the first electrode and the second electrode and configured to apply an electric field between the first electrode and the second electrode. This can be, for example, a power supply that can provide direct current (DC), or a power supply that can provide a biased fixed voltage.

In some embodiments, the recirculation well can further comprise a pump operatively connected to the central conduit and configured to provide a flow of a gas (e.g., air) from the discharge port into the internal passageway. The flow of gas can be used to induce the flow of water within the aquifer through the recirculation well (e.g., along the annular path for fluid flow axially (336) extending from the fluid inlet (332), between the first electrode (324) and the second electrode (326) of the concentric electrode assembly, and to the fluid outlet (334)) via convection.

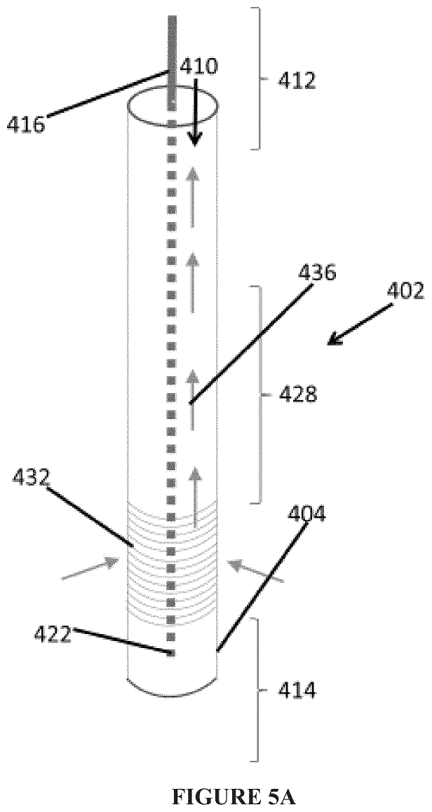

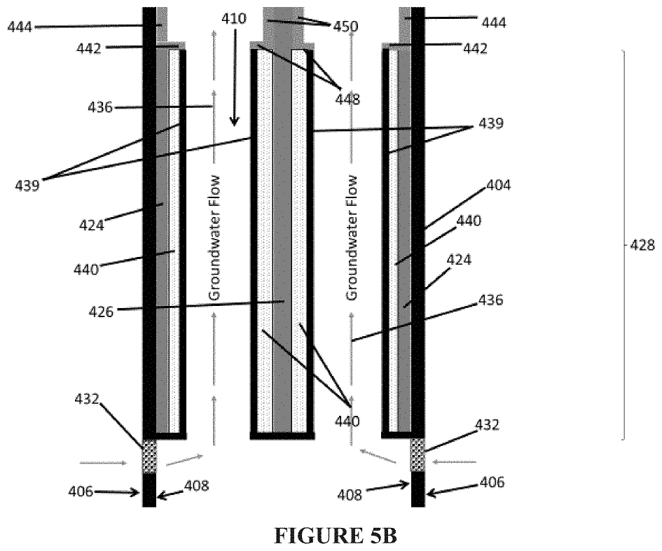

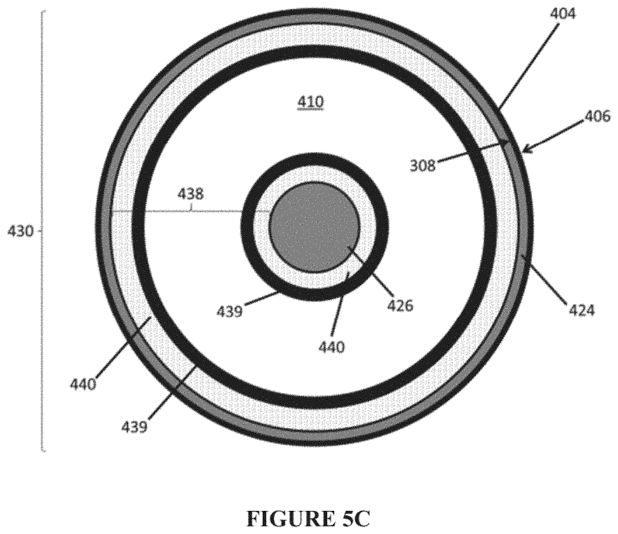

An alternative in-well desalination system is schematically illustrated in FIGS. 5A-5C. Referring now to FIGS. 5A-5C, provided herein are in-well desalination systems (402) that comprise a tubular casing (404) having an outer wall (406) and an inner wall (408) defining an internal passageway (410) axially extending from an uphole region (412) to a downhole region (414); and a concentric electrode assembly (424 and 426 in combination) positioned within an impermeable body portion (428) of the casing. In some embodiments, the diameter (430, outer diameter) of the tubular casing can be from 4 inches to 24 inches (e.g., from 7 inches to 14 inches). The casing can comprise a fluid inlet (432) fluidly connecting the outer wall of the casing to the internal passageway; and the impermeable body portion (428) disposed between and axially separating the fluid inlet (432) from the uphole region (416). In some cases, the fluid inlet can comprise a region of the casing formed from a screen or mesh.

The concentric electrode assembly can comprise a first electrode (424) circumferentially disposed about the inner wall (408) of the casing; and a second electrode (426) opposite the first electrode and axially extending through the internal passageway. As described in conjunction with the recirculation wells above, the electrodes can comprise a conductive material, such as a metal, disposed on or within the inner wall of the casing and/or positioned (e.g., centrally) within the internal passageway. Alternatively, in some embodiments, the first electrode can be a portion of the inner wall of the casing that is formed from a conductive material, such as a metal (i.e., the casing can function as the first electrode). In some cases, the first electrode can comprise an anode and the second electrode can comprise a cathode. In other cases, the first electrode can comprise a cathode and the second electrode can comprise an anode.

Within the impermeable body portion (428) of the casing, the inner wall (408) of the casing and the second electrode (426) together define a path for fluid flow (436) axially extending from the fluid inlet (432), and through the internal passageway (410) between the first electrode (424) and the second electrode (426) of the concentric electrode assembly. The fluid flow path can continue to a fluid outlet (not shown, uphole of the concentric electrode assembly) through which fluid can flow back into the aquifer, or to a point above ground, at which point the fluid can optionally be injected back into the aquifer. In some embodiments, the first electrode (424) can be separated from the second electrode (426) by a distance (438) of from 2 inches to 12 inches (e.g., from 2 inches to 6 inches, or from 4 inches to 8 inches).

In some embodiments, a low permeability membrane (439) can be disposed between the path for fluid flow (436) and the first electrode (424), disposed between the path for fluid flow (436) and the second electrode (426), or a combination thereof The low permeability membrane can be any suitable low permeability membrane described above. The low permeability membrane (439) can be spaced apart from the first electrode (424) and spaced apart from the second electrode (426), so as to form an accumulation reservoir (440) between the first electrode (424) and the low permeability membrane, and an accumulation reservoir (440) between the second electrode (426) and the membrane. During device operation, application of an electric field between the first electrode (424) and the second electrode (426) can induce migration of cations in the water through the low permeability membranes (439), and into the accumulation reservoirs (440).

Referring now to FIG. 4B, in some cases, the recirculation well can further comprise a port (442) fluidly connecting a withdrawal conduit (444) to an accumulation reservoir (440) between the first electrode (424) and the low permeability membrane (439), a port (448) fluidly connecting a withdrawal conduit (450) to an accumulation reservoir (440) between the second electrode (426) and the low permeability membrane (439), or a combination thereof. The withdrawal conduits (444, 450) can be in fluid combination with a pump, and configured to allow fluid to he withdrawn from the accumulation reservoirs (439). In this way, contaminant ions electrokinetically concentrated in the accumulation reservoirs (439) during device operation can be removed from the aquifer.

In some embodiments, the recirculation well can further comprise a power source electrically connected to the first electrode and the second electrode and configured to apply an electric field between the first electrode and the second electrode. This can be, for example, a power supply that can provide direct current (DC), or a power supply that can provide a biased fixed voltage.

In some embodiments, the recirculation well can further comprise a pump operatively connected to the internal passageway and configured to provide a flow of water from the fluid inlet, and through the internal passageway between the first electrode and the second electrode of the concentric electrode assembly.

While FIGS. 4A-4C and 5A-5C illustrate in-well systems positioned vertically within a wellbore, it should be understood by those skilled in the art that these systems can also be deployed in wells having other directional configurations including horizontal wells, deviated wells, slanted wells, multilateral wells and the like. Accordingly, it should be understood by those skilled in the art that the use of directional terms such as above, below, upper, lower, upward, downward, left, right, uphole, downhole and the like are used in relation to the illustrative embodiments as they are depicted in the figures, the upward direction being toward the top of the corresponding figure and the downward direction being toward the bottom of the corresponding figure, the uphole direction being toward the surface of the well and the downhole direction being toward the toe of the well.

Also provided are methods for removing contaminant ions from water within an aquifer using the in-well systems provided herein. For example, provided herein are methods for removing contaminant ions from water within an aquifer that comprise (i) positioning an in-well system described herein within a wellbore in fluid communication with the aquifer; (ii) inducing flow of the water within the aquifer through the in-well system along a path for fluid flow axially extending between the first electrode and the second electrode of the concentric electrode assembly; (iii) applying an electric field between the first electrode and the second electrode to induce migration of ions in the water to regions proximate to the first electrode and the second electrode; and (iv) withdrawing the ions from the regions proximate to the first electrode and the second electrode, thereby removing contaminant ions from the water within the aquifer.

In some embodiments, the first electrode comprises a cathode and the second electrode comprises an anode, and step (iii) comprises applying an electric field between the cathode and the anode to induce migration of cations in the water to a region proximate to the cathode and migration of anions in the water to a region proximate to the anode. In other embodiments, the first electrode comprises an anode and the second electrode comprises a cathode, and step (iii) comprises applying an electric field between the cathode and the anode to induce migration of cations in the water to a region proximate to the cathode and migration of anions in the water to a region proximate to the anode.

As discussed above, the anions and cations can comprise any contaminant ions present within the aquifer. In some cases, the contaminant ions can comprise monovalent ions, divalent ions, trivalent ions, tetravalent ions, or combinations thereof, In some examples, the anions can comprise chloride ions, bromide ions, sulfate ions, nitrate, or a combination thereof. In some examples, the cations can comprise sodium ions, potassium ions, magnesium ions, calcium ions, ammonium ions, iron ions, arsenic ions, chromium ions, lead ions, copper ions, zinc ions, barium ions, or combinations thereof. In some examples, the contaminants may be strongly or weakly charged complexes. In some cases, the contaminants may be particles that have a net positive or negative charge in a fluid due to surface and/or shape effects (e.g., clay or other solid particles with angular shapes where net negative charges can build up on particle edges).

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods in addition to those shown and described herein are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. A method for removing contaminant ions from water within an aquifer, the method comprising;
(i) inducing flow of the water through a treatment region within the aquifer disposed between an anode and a cathode;
(ii) applying an electric field between the anode and the cathode to induce migration of anions in the water to a region proximate to the anode and migration of cations in the water to a region proximate to the cathode; and
(iii) withdrawing fluid from the region proximate to the anode and the region proximate to the cathode, thereby removing contaminant ions from the water within the aquifer
wherein the treatment region within the aquifer exhibits a hydraulic conductivity of at least 10⁻⁴ cm/sec, as measured by the standard method described in ASTM D5084-16a.

2. The method of claim 1, wherein the treatment region within the aquifer exhibits a hydraulic conductivity of from 10⁻⁴ cm/sec to 100 cm/sec, as measured by the standard method described in ASTM D5084-16a.

3. The method of any of claims 1-2, wherein the treatment region within the aquifer exhibits a hydraulic conductivity of at least 10⁻³ cm/sec, as measured by the standard method described in ASTM D5084-16a.

4. The method of any of claims 1-3, wherein the treatment region within the aquifer exhibits a hydraulic conductivity of at least 0.1 cm/sec, as measured by the standard method described in ASTM D5084-16a.

5. The method of any of claims 1-4, wherein the anions comprise chloride ions, bromide ions, sulfate ions, nitrate, or a combination thereof.

6. The method of any of claims 1-5, wherein the cations comprise sodium ions, potassium ions, magnesium ions, calcium ions, ammonium ions, iron ions, arsenic ions, chromium ions, lead ions, copper ions, zinc ions, barium ions, or combinations thereof.

7. The method of any of claims 1-6, wherein the anode is positioned within an anode well in fluid communication with the aquifer and the cathode is positioned within a cathode well in fluid communication with the aquifer.

8. The method of claim 7, wherein the method further comprises monitoring the physical and chemical properties of fluid in the anode well.

9. The method of any of claims 7-8, wherein the method further comprises monitoring the physical and chemical properties of fluid in the cathode well.

10. The method of any of claims 7-9, wherein the method further comprises monitoring and maintaining a minimum pH level of fluid in the anode well.

11. The method of any of claims 7-10, wherein the method further comprises maintaining the pH of fluid in the anode well within a specified range by measuring the pH of the fluid in the anode well and adding a pH adjusting solution to the anode well.

12. The method of any of claims 7-11, wherein the method further comprises monitoring and maintaining a maximum pH level of fluid in the cathode well.

13. The method of any of claims 7-12, wherein the method further comprises maintaining the pH of fluid in the cathode well within a specified range by measuring the pH of the fluid in the cathode well and adding a pH adjusting solution to the cathode well.

14. The method of any of claims 7-13, wherein the method further comprises monitoring a fluid level in the anode well and adjusting the fluid level in the anode well when the fluid level reaches a predetermined level.

15. The method of any of claims 7-14, wherein the method further comprises monitoring a fluid level in the cathode well and adjusting the fluid level in the anode well when the fluid level reaches a predetermined level.

16. The method of any of claims 1-15, wherein the treatment region is disposed along a path for fluid flow from an injection wellbore in fluid communication with the aquifer to an extraction wellbore spaced apart from the injection wellbore and in fluid communication with the aquifer; and
wherein inducing the flow of the water through a treatment region within the aquifer comprises injecting water through the injection wellbore into the aquifer and extracting water from the aquifer via the extraction wellbore, thereby inducing the flow of the water through the treatment region.

17. The method of any of claims 1-15, wherein the treatment region is disposed along a path for fluid flow from a recirculation well outlet in fluid communication with the aquifer to a recirculation well inlet in fluid communication with the aquifer; and
wherein inducing the flow of the water through a treatment region within the aquifer comprises drawing water through the recirculation well inlet and ejecting water from the recirculation well outlet, thereby inducing the flow of the water through the treatment region.

18. A recirculation well for removing contaminant ions from water within an aquifer, the system comprising:
a tubular casing having an outer wall and an inner wall defining an internal passageway axially extending from an uphole region to a downhole region, the casing comprising:
a fluid inlet fluidly connecting the outer wall of the casing to the internal passageway;
a fluid outlet fluidly connecting the outer wall of the casing to the internal passageway; and
an impermeable body portion disposed between and axially separating the fluid inlet and the fluid outlet;
a central conduit having an outer wall and an inner wall, the central conduit axially extending from the uphole region through the internal passageway to terminate in a discharge port positioned within the downhole region; and
a concentric electrode assembly positioned withinthe impermeable body portion of the casing, the concentric electrode assembly comprising:
a first electrode circumferentially disposed about the inner wall of the casing;
and
a second electrode opposite the first electrode and circumferentially disposed
about the outer wall of the central conduit
wherein, within the impermeable body portion of the casing, the inner wall of the casing and the outer wall of the central conduit together define an annular path for fluid flow axially extending from the fluid inlet, between the first electrode and the second electrode of the concentric electrode assembly, and to the fluid outlet.

19. The recirculation well of claim 18, wherein the id inlet comprises a region of the casing formed from a screen or mesh.

20. The recirculation well of claim 18 or 19, wherein the fluid outlet comprises a region of the casing formed from a screen or mesh.

21. The recirculation well of any of claims 18-20, further comprising a low permeability membrane disposed between the annular path for fluid flow and the first electrode, wherein the low permeability membrane is spaced apart from the first electrode so as to form an accumulation reservoir between the first electrode and the low permeability membrane.

22. The recirculation well of any of claims 18-21, further comprising a low permeability membrane disposed between the annular path for fluid flow and the second electrode, wherein the low permeability membrane is spaced apart from the second electrode so as to form an accumulation reservoir between the second electrode and the low permeability membrane.

23. The recirculation well of claim 21 or 22, wherein the low permeability membrane comprises an ion exchange polymer.

24. The recirculation well of any of claims 21-23, further comprising a port fluidly connecting a withdrawal conduit to the accumulation reservoir between the first electrode and the low permeability membrane.

25. The recirculation well of any of claims 22-24, further comprising a port fluidly connecting a withdrawal conduit to the accumulation reservoir between the second electrode and the low permeability membrane.

26. The recirculation well of any of claims 18-25, wherein the first electrode is separated from the second electrode by a distance of from 2 inches to 12 inches.

27. The recirculation well of any of claims 18-26, wherein the diameter of the tubular casing is from 4 inches to 24 inches.

28. The recirculation well of any of claims 18-27, further comprising a power source electrically connected to the first electrode and the second electrode and configured to apply an electric field between the first electrode and the second electrode.

29. The recirculation well of any of claims 18-28, further comprising a pump operatively connected to the central conduit and configured to provide a flow of a gas from the discharge port into the internal passageway.

30. A method for removing contaminant ions from water ithin an aquifer, the method comprising;
positioning the recirculation well of any of claims 18-29 within a wellbore in fluid communication with the aquifer;
(ii) inducing flow of the water within the aquifer through the recirculation well of any of claims 18-29 along the annular path for fluid flow axially extending from the fluid inlet, between the first electrode and the second electrode of the concentric electrode assembly, and to the fluid outlet;
(iii) applying an electric field between the first electrode and the second electrode to induce migration of ions in the water to regions proximate to the first electrode and the second electrode; and
(iv) withdrawing the ions from the regions proximate to the first electrode and the second electrode, thereby removing contaminant ions from the water within the aquifer.

31. The method of claim 30, wherein the first electrode comprises a cathode and the second electrode comprises an anode, and wherein step (iii) comprises applying an electric field between the cathode and the anode to induce migration of cations in the water to a region proximate to the cathode and migration of anions in the water to a region proximate to the anode.

32. The method of claim 30, wherein the first electrode comprises an anode and the second electrode comprises a cathode, and wherein step (iii) comprises applying an electric field between the cathode and the anode to induce migration of cations in the water to a region proximate to the cathode and migration of anions in the water to a region proximate to the anode.

33. The method of any of claims 30-32, wherein step (ii) comprises providing a flow of a gas from the discharge port into the internal passageway.

34. The method of claim 33, wherein the gas comprises air.

35. The method of any of claims 30-34, wherein the anions comprise chloride ions, bromide ions, sulfate ions, nitrate, or a combination thereof.

36. The method of any of claims 30-35, wherein the cations comprise sodium ions, potassium ions, magnesium ions, calcium ions, ammonium ions, iron ions, arsenic ions, chromium ions, lead ions, copper ions, zinc ions, barium ions, or combinations thereof.

37. A system comprising:
an injection wellbore in fluid communication with an aquifer and an extraction wellbore spaced apart from the injection wellbore and in fluid communication with the aquifer, thereby defining a path for fluid flow within the aquifer from the injection wellbore to the extraction wellbore;
an anode well in fluid communication with the aquifer;
a cathode well spaced apart from the anode well and in fluid communication with the aquifer; and
a treatment region within the aquifer disposed between the anode well and the cathode well, wherein the treatment region is disposed along the path for fluid flow within the aquifer from the injection wellbore to the extraction wellbore.

38. A system comprising
a recirculation well in fluid communication with an aquifer, the recirculation well comprising a fluid inlet and a fluid outlet spaced apart from the fluid inlet, thereby defining a path for fluid flow within the aquifer from the fluid outlet to the fluid inlet;
an anode well in fluid communication with the aquifer;
a cathode well spaced apart from the anode well and in fluid communication with the aquifer; and
a treatment region within the aquifer disposed between the anode well and the cathode well, wherein the treatment region is disposed along the path for fluid flow within the aquifer from the fluid outlet to the fluid inlet.

39. The system of claim 37 or 38, wherein the treatment region within the aquifer exhibits a hydraulic conductivity of at least 10⁻⁴ cm/sec, as measured by the standard method described in ASTM D5084-16a.

40. The system of any of claims 37-39, wherein the treatment region within the aquifer exhibits a hydraulic conductivity of from 10⁻⁴ cm/sec to 100 cm/sec, as measured by the standard method described in ASTM D5084-16a.

41. The system of any of claims 37-40, wherein the treatment region within the aquifer exhibits a hydraulic conductivity of at least 10 ⁻³ cm/sec, as measured by the standard method described in ASTM D5084-16a.

42. The system of any of claims 37-41, wherein the treatment region within the aquifer exhibits a hydraulic conductivity of at least 0.1 cm/sec, as measured by the standard method described in ASTM D5084-16a.

43. An in-well system for removing contaminant ions from water within an aquifer, the system comprising:
a tubular casing having an outer wall and an inner wall defining an internal passageway axially extending from an uphole region to a downhole region, the casing comprising:
a fluid inlet fluidly connecting the outer wall of the casing to the internal passageway; and
an impermeable body portion disposed between and axially separating the fluid inlet and the uphole region; and
a concentric electrode assembly positioned within the impermeable body portion of the casing, the concentric electrode assembly comprising:
a first electrode circumferentially disposed about the inner wall of the casing; and
a second electrode opposite the first electrode and axially extending through the internal passageway;
wherein, within the impermeable body portion of the casing, the inner wall of the casing and second electrode together define a path for fluid flow axially extending from the fluid inlet, and through the internal passageway between the first electrode and the second electrode of the concentric electrode assembly.

44. The system of claim 43, wherein the fluid inlet comprises a region of the casing formed from a screen or mesh.

45. The system of any of claims 43-44, further comprising a low permeability membrane disposed between the path for fluid flow and the first electrode, wherein the low permeability membrane is spaced apart from the first electrode so as to form an accumulation reservoir between the first electrode and the low permeability membrane.

46. The system of any of claims 43-45, further comprising a low permeability membrane disposed between the path for fluid flow and the second electrode, wherein the low permeability membrane is spaced apart from the second electrode so as to form an accumulation reservoir between the second electrode and the low permeability membrane.

47. The system of claim 45 or 46, wherein the low-permeability membrane comprises an ion exchange polymer.

48. The system of any of claims 45-47, further comprising a port fluidly connecting a withdrawal conduit to the accumulation reservoir between the first electrode and the low permeability membrane.

49. The system of any of claims 45-48, further comprising a port fluidly connecting a withdrawal conduit to the accumulation reservoir between the second electrode and the low permeability membrane.

50. The system of any of claims 43-49, wherein the first electrode is separated from the second electrode by a distance of from 2 inches to 12 inches.

51. The system of any of claims 43-50, wherein the diameter of the tubular casing is from 4 inches to 24 inches.

52. The system of any of claims 43-51, further comprising a power source electrically connected to the first electrode and the second electrode and configured to apply an electric field between the first electrode and the second electrode.

53. The system of any of claims 43-52, further comprising a pump operatively connected to the internal passageway and configured to provide a flow of water from the fluid inlet, and through the internal passageway between the first electrode and the second electrode of the concentric electrode assembly.

54. A method for removing contaminant ions from water within an aquifer, the method comprising;
(i) positioning the in-well system of any of claims 43-53 within a wellbore in fluid communication with the aquifer;
inducing flow of the water within the aquifer through the in-well system of any of claims 43-53 along the path for fluid flow axially extending from the fluid inlet, and through the internal passageway between the first electrode and the second electrode of the concentric electrode assembly;
applying an electric field between the first electrode and the second electrode to induce migration of ions in the water to regions proximate to the first electrode and the second electrode; and
(iv) withdrawing the ions from the regions proximate to the first electrode and the second electrode, thereby removing contaminant ions from the water within the aquifer.

55. The method of claim 54, wherein the first electrode comprises a cathode and the second electrode comprises an anode, and wherein step (iii) comprises applying an electric field between the cathode and the anode to induce migration of cations in the water to a region proximate to the cathode and migration of anions in the water to a region proximate to the anode.

56. The method of claim 54, wherein the first electrode comprises an anode and the second electrode comprises a cathode, and wherein step (iii) comprises applying an electric field between the cathode and the anode to induce migration of cations in the water to a region proximate to the cathode and migration of anions in the water to a region proximate to the anode.

57. The method of any of claims 54-56, wherein the anions comprise chloride ions, bromide ions, sulfate ions, nitrate, or a combination thereof.

58. The method of any of claims 54-57, wherein the cations comprise sodium ions, potassium ions, magnesium ions, calcium ions, ammonium ions, iron ions, arsenic ions, chromium ions, lead ions, copper ions, zinc ions, barium ions, or combinations thereof.
